(19) United States
(12) Patent Application Publication
(10) Pub. No.: US 2026/0028450 A1
(43) Pub. Date: Jan. 29, 2026

(54) SILANE-TERMINATED POLYMERS

(71) Applicant: MERZ + BENTELI AG, Niederwangen (CH)

(72) Inventors: Stefan HUBER, Langenthal (CH); Thomas ZUBER, Rubigen (CH); Claude LERF, Meyriez (CH); Fritz BURKHARDT, Oberburg (CH)

(73) Assignee: MERZ + BENTELI AG, Niederwangen (CH)

(21) Appl. No.: 18/997,698

(22) PCT Filed: Jul. 19, 2023
(86) PCT No.: PCT/EP2023/070071

§ 371 Date: Jan. 22, 2025

(30) Foreign Application Priority Data
Jul. 22, 2022 (EP) 22186374.9

(51) Int. Cl. C08G 63/91; C08G 64/42; C09D 167/02; C09D 169/00; C09J 5/00; C09J 167/02; C09J 169/00

(52) U.S. Cl. CPC C08G 63/916; C08G 64/42; C09D 167/02; C09D 169/005; C09J 5/00; C09J 167/02; C09J 169/005

(57) ABSTRACT

A surface sealant or jointing material composition contains at least 20 wt. % of a silane-terminated polymer, the polymer backbone of which is selected from a polycarbonate, a polyester, a copolymer containing a polyester and/or a polycarbonate and a polymer containing at least one ester group and/or carbonate group. This backbone contains a plurality of diol monomer at least 60% of which contain a diol of formula HO—Z—OH, wherein Z is a saturated or unsaturated hydrocarbon chain optionally containing one or more heteroatoms selected from oxygen, sulfur and a tertiary nitrogen, Z includes at least one side chain and/or at least one cyclic ring system and/or at least one double bond and the composition is free from hardening catalysts or residues thereof selected from base catalysts having a pKa value greater than 15 and from by-products that may arise by cleaving of a leaving group with silane termination of the polymer.

The present invention relates to the use of a composition containing silane-terminated polymers.

The silane-terminated polymers are prepared by known methods. A known process comprises, for example, the reaction of polyols, in particular hydroxyl-terminated polyethers, polyurethanes or polyesters, and also of hydroxyl-functional polyacrylates, with (isocyanatoalkyl)alkoxysilanes.

Another method envisages a reaction of the aforementioned polyols with di- or polyisocyanates, using the latter in excess, so that isocyanate-functional polymers are produced in this first reaction step and are then reacted in a second reaction step with alkoxysilanes having an alkyl-bonded isocyanate-reactive group.

EP1987108 discloses a one-component, anhydrous coating compound based on silane-terminated polymers, consisting of a mixture containing various silane-terminated polyoxyalkylenes.

EP0824574 discloses the use of a two-component sealant based on silane-terminated polyether prepolymers, wherein the second component serves as crosslinker for the prepolymers.

EP0442380 discloses a contact adhesive consisting of silane-terminated polyoxyalkylenes. Also mentioned is a method of bonding adhesive surfaces.

EP0342411 discloses that specific stabilizers, for example monomeric isocyanates, should be added to the silane-terminated polymers in order to increase the flow resistance of the sealing compounds to a level usable in practice.

US20150291839 discloses liquid, moisture-curing compositions containing a silane-terminated moisture-curing polymer and an inorganic adhesion promoter.

WO2017140689 discloses the use of a composition comprising at least one room temperature liquid polymer containing silane groups, at least one liquid epoxy resin and at least one aliphatic polyamine having a molecular weight of at least 115 g/mol and having at least three amines reactive toward epoxy groups, as a sealing film applied in liquid form.

US 2022/220245 discloses a composition comprising a silane-terminated polymer as surface seal or join material. However, the composition disclosed has reduced storage stability.

WO2020094685 discloses a composition comprising a silane-terminated polymer as surface seal or join material. Isocyanate-free production has been found to be disadvantageous in the case of applications that are subjected to high temperatures since the reaction forms by-products such as phenols that cannot be removed from the end product. This problem has both environmental effects, since such substances can be exuded and get into the environment, and adverse consequences for the quality of the end product, since they lead to yellowing.

It has been found in practice that silane-terminated polymers based on polyethers have inadequate UV stability. Although silane-terminated polymers based on polyesters and/or polycarbonate have high UV stability, they frequently have relatively low storage stability.

It was therefore an object of the present invention to provide a composition containing silane-terminated polymers which have improved storage stability and improved weathering stability and in particular UV stability, and which do not contain any by-products of environmental concern.

The object is achieved by the composition of the invention. Further preferred embodiments are the subject matter of the dependent claims.

It has been found that the composition of the invention containing at least 20% by weight of a silane-terminated polymer of the formula (I) or (II), where the percentages by weight are based on the total content of silane-terminated polymers, and the composition contains a curing catalyst and is free of curing catalysts or residues thereof selected from the group of base catalysts having a pKa of greater than 15, preferably greater than 12, is of excellent suitability as surface seal or joining material since they have both good storage stability and high weathering stability and in particular UV stability. The combination of the branched diol monomer units and the choice of curing catalyst significantly extend storage stability. Moreover, the polymers of the invention are free of by-products that can form via elimination of a leaving group in the case of silane termination of the polymer.

At least 60 mol % of the diol monomer units, present in the polymer backbone A, of the silane-terminated polymer of the general formula I or II

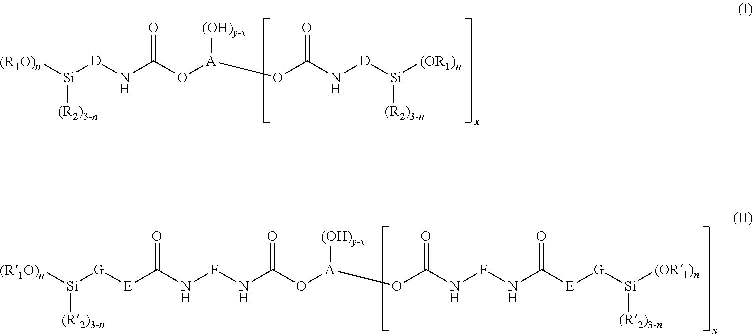

do not have a linear saturated alkylene group, but rather have at least one side chain, one ring system or one double bond. This steric change surprisingly leads to a significantly better storage stability of the composition.

By virtue of the preparation of the inventive silane-terminated polymer of the general formula (I) or (II) and subsequent curing of the formulation with a primary, secondary or oligomeric aminoalkoxysilane, it is possible to avoid unwanted by-products that can form in an isocyanate-free preparation of the silane-terminated polymer. Specifically at high temperatures, such compounds can be exuded, which is environmentally disadvantageous and also adversely affects the quality of surface coverage. The avoidance of these by-products makes it possible to obtain long-lived and in particular visually appealing surface coverage.

In the compounds of general formulae I and II
D is a linear or branched hydrocarbon group having 1 to 20 hydrocarbon atoms, which may optionally be interrupted by heteroatoms selected from the group consisting of oxygen, nitrogen and sulfur,
A is a polymer backbone selected from the group consisting of a polycarbonate, a polyester, a copolymer containing a polyester and/or a polycarbonate and a polymer containing at least one ester group and/or carbonate group, and where this polymer backbone A contains multiple diol monomer units,
R₁, R₂, R₁′ and R₂′ are each independently a linear, branched or cyclic hydrocarbyl radical which has 1 to 10 carbon atoms and may optionally comprise one or more heteroatoms selected from the group consisting of oxygen, sulfur and nitrogen,
n is the natural number 1, 2 or 3,
x and y are natural numbers between 1 and 10,
G is a linear or branched hydrocarbon group having 1 to 20 hydrocarbon atoms, which may optionally be interrupted by heteroatoms selected from the group consisting of oxygen, nitrogen and sulfur,
F is a linear, branched or cyclic organic radical which does not contain any isocyanate-reactive groups,
E is a functional group selected from the group consisting of NH, NR₄ and S, and
R₄ is a linear, branched or cyclic hydrocarbyl radical which has 1 to 10 carbon atoms and may optionally comprise one or more heteroatoms selected from the group consisting of oxygen, sulfur and nitrogen.

In the present invention, a urethane catalyst is a catalyst that catalyzes the reaction of the hydroxy-terminated polymer backbone with an isocyanatosilane or a polyfunctional isocyanate.

A curing catalyst means a catalyst that catalyzes the reaction of the compound of the general formula I or II to form the cured surface seal or the cured join material.

The expression “silane termination” means the reaction step in which the terminal silane group is joined to a silane-terminated polymer. The leaving group formed in the detachment in the silane termination of the polymer is a group of atoms having high electron density that can be readily eliminated in the silane termination. Examples of such leaving groups are aromatic phenols.

At least 60 mol % of the diol monomer units present in the polymer backbone A are a diol of the general formula III

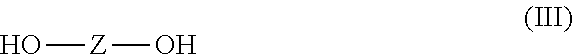

where
Z is a saturated or unsaturated hydrocarbon chain that may optionally contain one or more heteroatoms selected from the group consisting of oxygen, sulfur and a tertiary nitrogen, characterized in that Z has
   (a) at least one side chain and/or
   (b) at least one cyclic ring system and/or
   (c) at least one double bond.

The composition of the invention contains a curing catalyst. However, the choice of curing catalyst is crucial to the storage stability of the formulation of the invention. It is free of curing catalysts selected from the group of base catalysts having a pKa of greater than 15, preferably greater than 12. It has been found that base catalysts that are typically used for the curing of polymers adversely affect storage stability since they can lead to splitting of the polyesters or of the polycarbonates. For example, the commonly used cyclic amidine DBU, which has a pKa of 24.3 in MeCN, leads to a significant reduction in storage stability. By contrast, curing catalysts having a pKa of less than 15, preferably less than 12, have no adverse effect on storage stability.

Preferably, the curing catalyst contains an aminoalkoxysilane or consists of an aminoalkoxysilane or a mixture of aminoalkoxysilanes,

since these are also incorporated by reaction into the polymer network and hence cannot be washed out at a later stage. These additionally also act as an adhesion promoter. The term “aminoalkoxysilanes” especially means primary, secondary or oligomeric aminoalkoxysilanes. A primary aminoalkoxysilane means a compound in which a primary amine is bonded via a linker to the alkoxysilane group, whereas, in the case of a secondary aminoalkoxysilane, a secondary amine group is bonded via a linker to the alkoxysilane group. Secondary aminoalkoxysilanes are exemplified by N-butyl-3-aminopropyltrimethoxysilane and N-methyl-3-aminopropyltrimethoxysilane. It is likewise possible for primary and secondary amino groups to be bonded to the alkoxysilane group by a linker, for example N-(2-aminoethyl)-3-aminopropyltrimethoxysilane. An oligomeric aminoalkoxysilane is a chemical compound consisting of a chain or group of mutually bonded aminoalkoxysilane molecules. One example of an oligomeric aminoalkoxysilane is, for example, oligomeric diamino-functional Dynasylan 1146 from Evonik or the 3-aminopropyltriethoxysilane dimer (DAPTES dimer). This consists of two molecules of the 3-aminopropyltriethoxysilane monomer.

Preferred curing catalysts are selected from the group consisting of 3-aminopropyltrimethoxysilane, 3-aminopropyldimethoxymethylsilane, 3-amino-2-methylpropyltrimethoxysilane, 4-aminobutyltrimethoxysilane, 4-aminobutyldimethoxymethylsilane, 4-amino-3-methylbutyltrimethoxysilane, 4-amino-3,3-dimethylbutyltrimethoxysilane, 4-amino-3,3-dimethylbutyldimethoxymethylsilane, 2-aminoethyltrimethoxysilane, 2-aminoethyldimethoxymethylsilane, aminomethyltrimethoxysilane, aminomethyldimethoxymethylsilane, aminomethylmethoxydimethylsilane and 7-amino-4-oxaheptyldimethoxymethylsilane, N-(2-aminoethyl)-3-aminopropyltrimethoxysilanes, N-(2-aminoethyl)-3-aminopropylmethyldimethoxysilane, N-(2-aminoethyl)-3-aminopropyltriethoxysilane, 3-[2-(2-aminoethylamino)ethylamino]propyltrimethoxysilane, 3-[2-(2-aminoethylamino)ethylamino]propyltriethoxysilane, 3-[2-(2-aminoethylamino)ethylamino]propylmethyldimethoxysilane,
[3-(1-piperazinyl)propyl]triethoxysilane, [3-(1-piperazinyl)propyl]trimethoxysilane, [3-(1-piperazinyl)propyl]methyldimethoxysilane, N-(n-butyl)-3-aminopropyltrimethoxysilane, N-(n-butyl)-3-aminopropylmethyldimethoxysilane, N-(n-butyl)-3-aminopropyltriethoxysilane, N-ethylaminoisobutyltrimethoxysilane, N-ethylaminoisobutylmethyldimethoxysilane, N-cyclohexyl-3-aminopropyltriethoxysilane, N-cyclohexyl-3-aminopropyltrimethoxysilane, N-cyclohexylaminomethyltriethoxysilane, N-cyclohexylaminomethyltrimethoxysilane, N-cyclohexylaminomethyldimethoxymethylsilane, bis(trimethoxysilylpropyl)amine, and oligomeric diamino-functional Dynasylan 1146 from Evonik.

The curing catalyst present in the composition is preferably also free of any metal catalyst and residues thereof, since these too can have an unfavorable effect on storage stability. Examples of such metal catalysts are organotin compounds such as dibutyltin dilaurates, zinc(II) carboxylates, chromium(IV) carboxylates, bismuth(III) carboxylates and potassium(I) carboxylates.

As mentioned, the polymer backbone A is selected from the group consisting of polyesters, polycarbonates and copolymers comprising a polyester and/or a polycarbonate. The expression “copolymers comprising a polyester and/or a polycarbonate” is understood to mean polymers composed of two or more monomer units. In addition to alternating copolymers and graft copolymers, the term also includes, in particular, block polymers which consist of longer sequences or blocks of each monomer and can be linked to one another via linker compounds. Preferred combinations of blocks are
polyesters and polycarbonates
various polyesters
polyesters and polyethers, and
polycarbonates and polyethers.

The expression “copolymer comprising a polyester and/or a polycarbonate” means a copolymer comprising at least one block composed of a polyester and/or a polycarbonate and containing further blocks. In such a copolymer, the polyester content or the polycarbonate content is at least 10% by weight, preferably at least 25% by weight and most preferably at least 50% by weight.

Preferred linker compounds form urethane, ester, urea and amide bonds in the linking, more preferably urethane bonds.

The polymer backbone A contains one or more ester and/or carbonate groups. They preferably contain more than 2, more preferably more than 10 ester and/or carbonate groups. Within the present invention, the definition of the polymer backbone A also includes polymers extended with a linker compound, such as polymers terminally extended with a diol, polymers that have been dimerized or oligomerized by means of a diisocyanate or dicarbonyl dichloride, and copolymers which have been copolymerized using diisocyanates or dicarbonyl dichlorides. Such polymers may have 1, 2 or preferably 3 and more ester and/or carbonate groups within the polymer backbone.

Z is a saturated or unsaturated hydrocarbon chain that may optionally contain one or more heteroatoms selected from the group consisting of oxygen, sulfur and a tertiary nitrogen, wherein Z has
(a) at least one side chain and/or
(b) at least one cyclic ring system and/or
(c) at least one double bond.

The term “side chain” in the present invention means a branch in the saturated or unsaturated hydrocarbon chain. In a preferred embodiment, this is an electron-donating group. Suitable examples of side chains are a C₁-C₁₀ alkyl, a C₁-C₁₀ alkenyl, preferably with a terminal double bond, a C₁ to C₁₀ alkoxy, a C₁ to C₅ tertiary alkylamino group, an acrylate or a methacrylate. Alkenyl groups having a terminal double bond, acrylates and methacrylates have the advantage that the therefrom silane-terminated polymers can be further crosslinked by free-radical means by radiation and heat.

In one embodiment, Z is an alkylene group having one or more side chains. In the context of the present invention, the term “alkylene group” represents a divalent hydrocarbon radical preferably having 3 to 20 carbon atoms. This has at least one side chain. The side chain may, for example, be a C₁-C₁₀ alkyl, a C₁-C₁₀ alkenyl, a C₁ to C₁₀ alkoxy, a C₁ to C₅ tertiary alkylamino group, an acrylate or a methacrylate.

In one embodiment, Z is an alkenylene group that may have one or more side chains. In the context of the present invention, the term “alkenylene group” represents a divalent hydrocarbon radical having at least one double bond and preferably having 3 to 20 carbon atoms. Examples of the optional side chains are, for example, a C₁-C₁₀ alkyl, a C₁-C₁₀ alkenyl, a C₁ to C₁₀ alkoxy, a C₁ to C₅ tertiary alkylamino group, an acrylate or a methacrylate.

In one embodiment, Z is a hydrocarbon chain containing at least one cyclic ring system. In the context of the present invention, the term “cycloalkylene group” represents a divalent, saturated or partially unsaturated, monocyclic, bicyclic or polycyclic ring structure that may be unsubstituted or substituted. The cyclic ring structure may be bonded to the OH groups of the diol of the formula III either directly or via an alkylene group.

Z may be a saturated or unsaturated hydrocarbon chain containing one or more heteroatoms selected from the group consisting of oxygen (i.e. forming an ether), sulfur (i.e. forming a thioether or a thioester) and a tertiary nitrogen (i.e. forming a tertiary amine), which have one or more side chains that may, for example, be a C₁-C₁₀ alkyl, a C₁-C₁₀ alkenyl, a C₁ to C₁₀ alkoxy, a C₁ to C₅ tertiary alkylamino group, an acrylate or a methacrylate.

The composition of the invention is preferably free of phthalates. The composition of the invention is compatible with a wide variety of plasticizers, which makes it possible to dispense with phthalates that are harmful to health. Preferred non-reactive plasticizers are, for example, phenyl alkanesulfonates such as Mesamoll from Lanxess, cyclohexanoate plasticizers such as Elatur DINCD from Evonik, diisononyl 1,2-cyclohexanedicarboxylates such as Hexamoll DINCH from BASF, and diesters of dicarboxylic acids such as dioctyl sebacate, dioctyl adipate or dioctyl azelate. It is likewise also possible to use non-silane-terminated polyesters or polyether glycols, polystyrenes, polybutadienes, polyisobutylenes, paraffinic hydrocarbons, and branched hydrocarbons of high molecular weight.

Depending on the substrate to be sealed, it is also possible to add reactive plasticizers, for example various linear or branched alkylsilanes (for example N-octyltrimethoxysilane, N-octyldimethoxymethylsilane), monofunctionally silane-terminated polyether polyols (commercially available, for example, as Geniosil XM20, Geniosil XM25, SAT 145, Silquest A-1230 Silane) or likewise alternative monofunctional polymer chains to the composition of the invention.

The composition of the invention contains at least 20% by weight of a silane-terminated polymer of the formula (I) or (II), where the percentages by weight are based on the total content of silane-terminated polymers. The further silane-terminated polymers present in the composition may, for example, be silane-terminated polymers having a polymer backbone based on a polyether, polyacrylate or polyurethane. In one embodiment, the composition of the invention contains at least 25% by weight, preferably 50% by weight, more preferably 75% by weight, of the silane-terminated polymer of the formula (I) or (II), where the percentages by weight are based on the total content of silane-terminated polymers. The higher the proportion of silane-terminated polymers of the formula (I) or (II), the greater the improvement in weathering resistance.

Possible embodiments are, for example, mixtures of silane-terminated polymers of the formula (I) and/or (II) with
dimethoxy(methyl)silylmethyl carbamate-terminated polyethers, for example Geniosil STP-E10 or STP-E30 from Wacker;
trimethoxysilylpropyl carbamate-terminated polyethers, for example Geniosil STP-E15 or STP-E35 from Wacker, Desmoseal S XP 2636, S XP 2749 from Covestro, Polymer NPT 20S from NPT, SPUR+ 1015 and SPUR+ 1050 from Momentive, Polymer ST 61, Polymer ST 61LV, Polymer ST 80, Polymer ST 81 from Evonik, Risun 15000T, Risun 30000T from Risun;
dimethoxymethylsilane-terminated polyether polymers, for example Polymer S203H, S303H, SAX220, SAX260, SAX350, SAX 400 from Kaneka;
trimethoxysilane-terminated polyether polymers, for example SAX510, SAX520, SAX530, SAX580, SAX 590 from Kaneka;
acryloyl-modified dimethoxymethylsilane-terminated polyether polymers, for example MAX602, MAX 923, MAX951 from Kaneka;
acryloyl-modified trimethoxysilane-terminated polyether polymers, for example MA490 from Kaneka;
dimethoxysilane-terminated polyacrylates, for example XMAP SA100S, SA110S, SA120S, SA310S, SA420S from Kaneka; and
trimethoxysilane-terminated polyurethanes, for example Desmoseal S XP 2458 or S XP 2821 from Covestro.

More preferably, the composition of the invention contains at least 20% by weight of a silane-terminated polymer of the formula (I) or (II), where the percentages by weight are based on the total content of silane-terminated polymers and a further silane-terminated polymer selected from the group consisting of dimethoxy(methyl)silylmethyl carbamate-terminated polyethers and trimethoxysilylpropyl carbamate-terminated polyethers and mixtures thereof is present.

In a preferred embodiment of the present invention, the silane-terminated polymers of the general formula I or II are linear polymers, i.e. x and y are 1. Alternatively, the silane-terminated polymers of the general formula I or II may also be branched polymers. In order to prepare these, a very small portion (about 1 molecule/polymer) of a triol or tricarboxylic acid is used.

In a preferred embodiment of the present invention, Z is a branched alkylene group. This branched alkylene group, i.e. saturated hydrocarbon group, contains at least one side chain. More preferably, the at least one side chain of this alkylene group is selected from the group consisting of methyl, ethyl, propyl, butyl, acrylate and methacrylate, preferably methyl.

In a preferred embodiment, at least 75 mol %, preferably at least 90 mol %, more preferably at least 95 mol % and ideally virtually all diol monomer units contain a diol of the general formula III. The higher the proportion of diols of the general formula III, the better the storage stability of the polymer of the formula I or II in the composition of the invention.

In one embodiment of the present invention, the diol of the formula III is selected from the group consisting of neopentyl glycol, propane-1,2-diol, cyclohexane-1,4-dimethanol, 3-methylpentane-1,5-diol, 2-methylpentane-2,4-diol, hexane-2,5-diol, 2-butyl-2-ethylpropane-1,3-diol, 2-methylpropane-1,3-diol, 3-ethylpentane-1,5-diol, 2,4-diethylpentane-1,5-diol, 2,2,4-trimethylpentane-1,3-diol, butane-2,3-diol, 2-ethylpentane-1,5-diol, 2,2-dimethylpropane-1,3-diol, 2-ethylhexane-1,3-diol, 1,5-hexadiene-3,4-diol, 7-octene-1,2-diol and (9Z,12Z)-18-[(6Z,9Z)-18-hydroxyoctadeca-6,9-dienoxy]octadeca-9,12-dien-1-ol or a mixture thereof. Polymers of the general formula I or II containing the abovementioned diol of the formula III have particularly good stability. Particularly high stability was achievable with 3-methylpentane-1,5-diol. The preparation of such polymers is known to the person skilled in the art.

In one embodiment of the present invention, A contains a polyester. This can be obtained, for example, by reacting a diol of the general formula III, for example diols selected from the group consisting of neopentyl glycol, propane-1,2-diol, cyclohexane-1,4-dimethanol, 3-methylpentane-1,5-diol, 2-methylpentane-2,4-diol, hexane-2,5-diol, 2-butyl-2-ethylpropane-1,3-diol, 2-methylpropane-1,3-diol, 3-ethylpentane-1,5-diol, 2,4-diethylpentane-1,5-diol, 2,2,4-trimethylpentane-1,3-diol, butane-2,3-diol, 2-ethylpentane-1,5-diol, 2,2-dimethylpropane-1,3-diol, 2-ethylhexane-1,3-diol, 1,5-hexadiene-3,4-diol, 7-octene-1,2-diol and (9Z,12Z)-18-[(6Z,9Z)-18-hydroxyoctadeca-6,9-dienoxy]octadeca-9,12-dien-1-ol or mixtures thereof with at least one component containing carboxyl groups, selected from aliphatic acids having two carboxyl groups, such as succinic acid, glutaric acid, adipic acid, pimelic acid, suberic acid, azelaic acid, sebacic acid, dodecanedioic acid, brassylic acid and dimer acids, or dialkyl esters of acids having two carboxyl groups, such as dimethyl esters, diethyl esters, dipropyl esters and dibutyl esters or carbonyl chlorides such as acryloyl or methacryloyl chloride; alicyclic dicarboxylic acids such as cyclohexane-1,4-dicarboxylic acid, or dialkyl esters of acids having two carboxyl groups, such as dimethyl esters, diethyl esters, dipropyl esters and dibutyl esters; aromatic acids having two carboxyl groups, such as phthalic acid, isophthalic acid, terephthalic acid and naphthalenedicarboxylic acid, or dialkyl esters of acids having two carboxyl groups, such as dimethyl esters, diethyl esters, dipropyl esters and dibutyl esters and the like, or mixtures thereof. The preparation of such polymers is known to the person skilled in the art.

Of these examples, preference is given to using adipic acid, azelaic acid, sebacic acid, terephthalic acid, isophthalic acid and naphthalenedicarboxylic acid or mixtures thereof. Also possible is the use of cyclic carboxylic anhydrides such as phthalic anhydride, maleic anhydride, succinic anhydride or with a side chain, for example 3-methylglutaric anhydride, or mixtures thereof. Aliphatic dicarboxylic acids or esters thereof having side chains may also be used, such as 2,4-diethylglutaric acid, 2,4-methylglutaric acid, 3-methylglutaric acid, methylmalonic acid or mixtures thereof. The diols and also the dicarboxylic acids may be petroleum-based or may have been produced from renewable raw materials. However, the expression “polyester” also includes polyesters formed by reaction of diols of the general formula III with caprolactone.

In one embodiment, the polymer backbone A contains a polycarbonate. Polycarbonates may be obtained, for example, by the reaction of diols of the formula III, for example diols selected from the group consisting of neopentyl glycol, propane-1,2-diol, cyclohexane-1,4-dimethanol, 3-methylpentane-1,5-diol, 2-methylpentane-2,4-diol, hexane-2,5-diol, 2-butyl-2-ethylpropane-1,3-diol, 2-methylpropane-1,3-diol, 3-ethylpentane-1,5-diol, 2,4-diethylpentane-1,5-diol, 2,2,4-trimethylpentane-1,3-diol, butane-2,3-diol, 2-ethylpentane-1,5-diol, 2,2-dimethylpropane-1,3-diol, 1,5-hexadiene-3,4-diol, 2-ethylhexane-1,3-diol, 7-octene-1,2-diol and (9Z,12Z)-18-[(6Z,9Z)-18-hydroxyoctadeca-6,9-dienoxy]octadeca-9,12-dien-1-ol or mixtures of two or more of these with diaryl carbonates, for example dimethyl carbonate, diethyl carbonate, diphenyl carbonate or phosgene. The preparation of such polymers is known to the person skilled in the art. The isocyanates of the formula (IV) used according to the invention

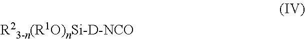

are commercially available products or can be produced by standard methods in silicon chemistry. R₁ and R₂ are each independently a linear, branched or cyclic hydrocarbon radical having 1 to 10 carbon atoms, which may optionally comprise one or more heteroatoms selected from the group consisting of oxygen, sulfur and nitrogen. n may have the value 1, 2 or 3, with the values 2 or 3 being preferred, since the silane-terminated polymers produced therefrom have a particularly balanced reactivity.

Preferably, R¹ and R² are each independently alkyl radicals, such as a methyl radical, ethyl radical, n-propyl radical, isopropyl radical, n-butyl radical, isobutyl radical, tert-butyl radical, n-pentyl radical, isopentyl radical, neopentyl radical, tert-pentyl radical, n-hexyl radical, n-heptyl radical, octyl radicals, n-octyl radical, isooctyl radicals, 2,2,4-trimethylpentyl radical, n-nonyl radical, decyl radicals, n-decyl radical, dodecyl radicals or an n-dodecyl radical. They may, however, also be alkenyl radicals, such as a vinyl radical or an allyl radical; cycloalkyl radicals, such as a cyclopentyl radical, cyclohexyl radical, cycloheptyl radical and methylcyclohexyl radicals; aryl radicals, such as the phenyl radical and the naphthyl radical; alkaryl radicals, such as o-, m-, p-tolyl radicals, xylyl radicals and ethylphenyl radicals; aralkyl radicals, such as the benzyl radical, the α-phenylethyl radical and the β-phenylethyl radical. Examples of substituted radicals R¹ are alkoxyalkyl radicals, such as ethoxyethyl radicals and methoxyethyl radicals.

Preferably, R¹ and R² radicals are each independently a hydrocarbon radical having 1 to 6 carbon atoms, particularly preferably an alkyl radical having 1 to 4 carbon atoms, in particular the methyl radical or ethyl radical.

D is a linear or branched hydrocarbon group having 1 to 20 hydrocarbon atoms, which may optionally be interrupted by heteroatoms selected from the group consisting of oxygen, nitrogen and sulfur. Preferably, D is selected from the group consisting of methylene, ethylene, propylene, butylene, methylene oxide, ethylene oxide and propylene oxide, and particularly preferably from propylene or methylene, since this results in polymers having a particularly balanced reactivity and these are readily commercially available.

Examples of isocyanates of the formula (IV) are isocyanatomethyldimethylmethoxysilane, isocyanatopropyldimethylmethoxysilane, isocyanatomethylmethyldimethoxysilane, isocyanatopropylmethyldimethoxysilane, isocyanatomethyltrimethoxysilane, isocyanatomethyltriethoxysilane, isocyanatopropyltriethoxysilane and isocyanatopropyltrimethoxysilane, preference being given to isocyanatomethylmethyldimethoxysilane, isocyanatopropylmethyldimethoxysilane, isocyanatopropyltrimethoxysilane, isocyanatopropyltriethoxysilane and isocyanatomethyltriethoxysilane.

The process according to the invention for preparing the silane-terminated polymer of the formula (II) is effected by reacting a hydroxy-terminated organic polymer of the formula (III)

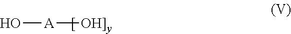

where A represents the above-defined polymer backbone

with a polyfunctional isocyanate of the formula (VI)

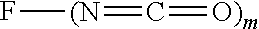

and subsequent reaction with an alkoxysilane of the formula (VII)

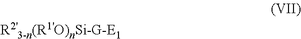

in the presence of a urethane catalyst, where E₁ is a reactive group that reacts with the isocyanate group, selected from the group consisting of NH₂, NHR₃ and SH, and F, m, R₁′, R₂′, n and G have the same definition as above. It has been found that this process leads to much better results compared to isocyanate-free processes since it is possible to avoid elimination products, by-products or degradation products of toxicological concern, which can also adversely affect the quality of the surface seals.

The reaction with the polyfunctional isocyanate of the formula (VI) is preferably conducted at 60-150° C., more preferably at 60-120° C.; the reaction with the alkoxysilane of the formula (VII) is preferably conducted at 0-100° C., more preferably at 20-60° C.

The hydroxy-terminated organic polymer of the formula (III) preferably has an average molecular weight of 1000-50 000 g/mol, in particular 2000-25 000 g/mol, since the handling of said polymers is optimal, optionally with addition of a plasticizer to improve processibility. In the present document, “molecular weight” means the molar mass (in grams per mole) of a molecule. “Average molecular weight” refers to the number-average molecular weight Mn of a polydisperse mixture of oligomeric or polymeric molecules, which is usually determined by titrating the acid number and OH number. It can alternatively also be determined by analytical methods such as GPC/MALDI. The OH number (hydroxyl number) is a measure of the hydroxyl group content in polymers and is a quantity known to those skilled in the art. The acid number is a measure of the content of acid groups in polymers and is a quantity known to those skilled in the art.

Particularly suitable polyfunctional isocyanates of the formula (VI) are isocyanates having two or more, preferably 2 to 10, isocyanate groups in the molecule. Suitable for this purpose are the known aliphatic, cycloaliphatic, aromatic, oligomeric and polymeric polyfunctional isocyanates which do not contain any isocyanate-reactive groups, i.e. in particular have no free primary and/or secondary amino groups. An example of a representative of the aliphatic polyfunctional isocyanates is hexamethylene diisocyanate (HDI); an example of a representative of the cycloaliphatic polyfunctional isocyanates is 1-isocyanato-3-(isocyanatomethyl)-3,5,5-trimethylcyclohexane.

Representatives of the aromatic polyfunctionalized isocyanates include: 2,4- and 2,6-diisocyanatotoluene and the corresponding technical isomer mixture (TDI); diphenylmethane diisocyanates, such as diphenylmethane 4,4′-diisocyanate, diphenylmethane-2,4′-diisocyanate, diphenylmethane 2,2′-diisocyanate and the corresponding technical isomer mixtures (MDI). In addition, mention should also be made of naphthalene-1,5-diisocyanate (NDI) and 4,4′,4″-triisocyanatotriphenylmethane.

Alkoxysilanes of the formula (VII) are preferably selected from the group consisting of 3-aminopropyltrimethoxysilane, 3-aminopropyldimethoxymethylsilane, 3-amino-2-methylpropyltrimethoxysilane, 4-aminobutyltrimethoxysilane, 4-aminobutyldimethoxymethylsilane, 4-amino-3-methylbutyltrimethoxysilane, 4-amino-3,3-dimethylbutyltrimethoxysilane, 4-amino-3,3-dimethylbutyldimethoxymethylsilane, 2-aminoethyltrimethoxysilane, 2-aminoethyldimethoxymethylsilane, aminomethyltrimethoxysilane, aminomethyldimethoxymethylsilane, aminomethylmethoxydimethylsilane and 7-amino-4-oxaheptyldimethoxymethylsilane, N-(2-aminoethyl)-3-aminopropyltrimethoxysilane, N-(2-aminoethyl)-3-aminopropylmethyldimethoxysilane, N-(2-aminoethyl)-3-aminopropyltriethoxysilane, 3-[2-(2-aminoethylamino)ethylamino]propyltrimethoxysilane, 3-[2-(2-aminoethylamino)ethylamino]propyltriethoxysilane, 3-[2-(2-aminoethylamino)ethylamino]propylmethyldimethoxysilane,
[3-(1-piperazinyl)propyl]triethoxysilane, [3-(1-piperazinyl)propyl]trimethoxysilane, [3-(1-piperazinyl)propyl]methyldimethoxysilane, N-(n-butyl)-3-aminopropyltrimethoxysilane, N-(n-butyl)-3-aminopropylmethyldimethoxysilane, N-(n-butyl)-3-aminopropyltriethoxysilane, N-ethylaminoisobutyltrimethoxysilane, N-ethylaminoisobutylmethyldimethoxysilane, N-cyclohexyl-3-aminopropyltriethoxysilane, N-cyclohexyl-3-aminopropyltrimethoxysilane, N-cyclohexylaminomethyltriethoxysilane, N-cyclohexylaminomethyltrimethoxysilane, N-cyclohexylaminomethyldimethoxymethylsilane, bis(trimethoxysilylpropyl)amine, 3-mercaptopropyltrimethoxysilane, 3-mercaptopropyltriethoxysilane and 3-mercaptopropylmethyldimethoxysilane.

The composition of the invention preferably contains at least 0.1% by weight of a UV stabilizer in order to further improve the stability of the composition.

A further embodiment of the present invention relates to a composition of the invention in which, when the diol of the formula III is 3-methylpentane-1,5-diol, the acid unit is not adipic acid.

Particularly good results were obtained with the following silane-terminated polymers selected from the group consisting of

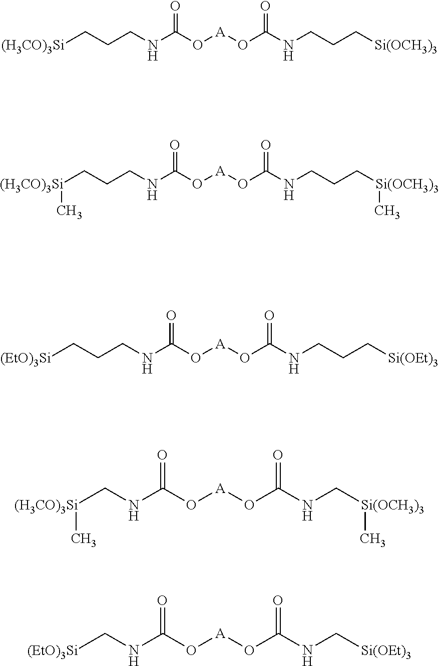

where A contains polyester units formed from monomer units selected from the group consisting of

| | | |
|---|---|---|
| A1 | neopentyl glycol | adipic acid |
| A2 | propane-1,2-diol | adipic acid |
| A3 | cyclohexane-1,4-dimethanol | adipic acid |
| A4 | 3-methylpentane-1,5-diol | adipic acid |
| A5 | 2-methylpentane-2,4-diol | adipic acid |
| A6 | hexane-2,5-diol | adipic acid |
| A7 | 2-butyl-2-ethylpropane-1,3-diol | adipic acid |
| A8 | 2-methylpropane-1,3-diol | adipic acid |
| A9 | 3-ethylpentane-1,5-diol | adipic acid |
| A10 | 2,4-diethylpentane-1,5-diol | adipic acid |
| A11 | 2,2,4-trimethylpentane-1,3-diol | adipic acid |
| A12 | butane-2,3-diol | adipic acid |
| A13 | 2-ethylpentane-1,5-diol | adipic acid |
| A14 | 2,2-dimethylpropane-1,3-diol | adipic acid |
| A15 | 2-ethylhexane-1,3-diol | adipic acid |
| A16 | 1,5-hexadiene-3,4-diol | adipic acid |
| A17 | 7-octene-1,2-diol | adipic acid |
| A18 | (9Z,12Z)-18-[(6Z,9Z)-18-hydroxyoctadeca- | adipic acid |
| | 6,9-dienoxy]octadeca-9,12-dien-1-o1 | |
| A19 | neopentyl glycol | azelaic acid |
| A20 | propane-1,2-diol | azelaic acid |
| A21 | cyclohexane-1,4-dimethanol | azelaic acid |
| A22 | 3-methylpentane-1,5-diol | azelaic acid |
| A23 | 2-methylpentane-2,4-diol | azelaic acid |
| A24 | hexane-2,5-diol | azelaic acid |
| A25 | 2-butyl-2-ethylpropane-1,3-diol | azelaic acid |
| A26 | 2-methylpropane-1,3-diol | azelaic acid |
| A27 | 3-ethylpentane-1,5-diol | azelaic acid |
| A28 | 2,4-diethylpentane-1,5-diol | azelaic acid |
| A29 | 2,2,4-trimethylpentane-1,3-diol | azelaic acid |
| A30 | butane-2,3-diol | azelaic acid |
| A31 | 2-ethylpentane-1,5-diol | azelaic acid |
| A32 | 2,2-dimethylpropane-1,3-diol | azelaic acid |
| A33 | 2-ethylhexane-1,3-diol | azelaic acid |
| A34 | 1,5-hexadiene-3,4-diol | azelaic acid |
| A35 | 7-octene-1,2-diol | azelaic acid |
| A36 | (9Z,12Z)-18-[(6Z,9Z)-18-hydroxyoctadeca- | azelaic acid |
| | 6,9-dienoxy]octadeca-9,12-dien-1-o1 | |
| A37 | neopentyl glycol | sebacic acid |
| A38 | propane-1,2-diol | sebacic acid |
| A39 | cyclohexane-1,4-dimethanol | sebacic acid |
| A40 | 3-methylpentane-1,5-diol | sebacic acid |
| A41 | 2-methylpentane-2,4-diol | sebacic acid |
| A42 | hexane-2,5-diol | sebacic acid |
| A43 | 2-butyl-2-ethylpropane-1,3-diol | sebacic acid |
| A44 | 2-methylpropane-1,3-diol | sebacic acid |
| A45 | 3-ethylpentane-1,5-diol | sebacic acid |
| A46 | 2,4-diethylpentane-1,5-diol | sebacic acid |
| A47 | 2,2,4-trimethylpentane-1,3-diol | sebacic acid |
| A48 | butane-2,3-diol | sebacic acid |
| A49 | 2-ethylpentane-1,5-diol | sebacic acid |
| A50 | 2,2-dimethylpropane-1,3-diol | sebacic acid |
| A51 | 2-ethylhexane-1,3-diol | sebacic acid |
| A52 | 1,5-hexadiene-3,4-diol | sebacic acid |
| A53 | 7-octene-1,2-diol | sebacic acid |
| A54 | (9Z,12Z)-18-[(6Z,9Z)-18-hydroxyoctadeca- | sebacic acid |
| | 6,9-dienoxy]octadeca-9,12-dien-1-o1 | |

The polyesters thus formed preferably have a molecular weight of 1000 g/mol to 20 000 g/mol.

More preferably, the composition of the invention is used for surface sealing of materials selected from the group consisting of mineral building materials, metals, tar papers, plastics (especially EPDM), fiber weaves, glass and ceramic. The composition of the invention has exceptionally good adhesion to these materials and protects these reliably from ingress of moisture. By virtue of the excellent weathering stability and in particular UV stability, it can also be used in places exposed to the sun.

More preferably, the composition of the invention is applied to surfaces that contain copper and/or bitumen, are in contact with copper or bitumen, or consist thereof. By contrast with the compositions used in the prior art, where accelerated breakdown of the material is found in the case of contact with copper and bitumen, the composition of the invention shows a distinct improvement in weathering stability.

The composition of the invention is suitable in particular for sealing of surfaces against ingress of water. It is suitable for sealing surfaces of external building surfaces, internal building faces (for example in wet rooms, where the coated surfaces may then also be covered with tiles or other decorative materials), roofs, swimming pools and the like.

The composition of the invention is of particularly good suitability as surface seal in the field of swimming pools. By virtue of its good stability to disinfectants, for example chlorine, the composition is suitable for horizontal and vertical joins and surface seals in contact with swimming pool water and the chemicals present therein.

In a particularly preferred embodiment, the composition of the invention is used for flat roof sealing, since these have to provide particularly tight sealing.

In a further embodiment, the composition of the invention may be used as surface sealing material with damping and/or acoustically or thermally insulating properties.

The composition of the invention may show thixotropic characteristics and can be applied both to horizontal and vertical surfaces. It is thus especially suitable as joining means for connection joins in the roofing sector, as joining means in the field of building shells, for example concrete joins or joins of wood facade elements, as joining means for vertical join seals and horizontal join seals, and as surface seal for joinless connections, for example in roof windows, ventilation pipes and roof sheets.

The composition of the invention may be transparent or translucent. This means that the surface to be sealed remains visible through the layer thickness used. Such systems must have particularly good weathering stability to remain stable over a prolonged period of time.

In a further embodiment, the composition of the invention is used together with a nonwoven or woven fabric. The nonwoven or woven fabric has good integration into the composition.

The composition of the invention is preferably applied to the surface to be sealed. The application is preferably effected by brush, roller, coating bar or commercial spray devices such as airless devices. Curing is preferably effected at temperatures of 0 to 50° C., preferably 10 to 40° C. The coatings obtained after curing are notable for high weathering stability.

The layer thicknesses of the composition of the invention are preferably 0.5 to 5 mm, more preferably 1 to 3 mm. The layer thickness can be applied in one step or in multiple steps. By virtue of the excellent properties of the composition of the invention, very thin layers are in particular also possible, which nevertheless have good sealing and are weathering-stable over a long period of time.

The silane-terminated polymers of the invention may also be formulated as a 2-component system. In addition to auxiliaries, the second component also comprises water, which greatly accelerates deep through-curing after mixing with the first component. Corresponding 2-component systems are known to those skilled in the art and are described, for example, in EP2009063 or EP2535376, the content of which is incorporated by reference.

The compositions of the invention may contain further auxiliaries and additives. These auxiliaries and additives include, for example, further silane-terminated polymers, plasticizers, stabilizers, antioxidants, fillers, reactive diluents, desiccants, adhesion promoters and UV stabilizers, rheological aids, color pigments, hollow microbeads or color pastes and/or possibly also solvents to a small extent. Such auxiliaries and additives are known to those skilled in the art.

The formulation of the present invention may be black, white, colored or transparent, meaning that the color can be matched to individual customer wishes.

### EXAMPLES

### Example 1

A silane-terminated Dynacoll 7250 (not in accordance with the invention, polyester based on linear ethane-1,2-diol, linear hexane-1,6-diol and small amounts of 2,2-dimethylpropane-1,3-diol and adipic acid) is compared with an inventive silane-terminated Kuraray P-6010 (3-methylpentane-1,5-diol as diol component, in accordance with the invention (i.e. a silane-terminated polymer of the formula I), and adipic acid as acid component). The curing catalyst used is 3-aminopropyltrimethoxysilane, which simultaneously acts as adhesion promoter.

| | Noninventive | Inventive |
|---|---|---|
| Trimethoxypropylsilane- | 35 | |
| terminated Dynacoll 7250 | | |
| Trimethoxypropylsilane- | | 35 |
| terminated Kuraray P-6010 | | |
| Plasticizer | 9 | 9 |
| Vinyltrimethoxysilane | 1 | 1 |
| Omyalite 95T | 50 | 50 |
| Titanium dioxide | 2 | 2 |
| Sterically hindered amine as | 0.1 | 0.1 |
| light stabilizer | | |
| Antioxidant | 0.4 | 0.4 |
| Polyamide wax | 2 | 2 |
| 3-Aminopropyltrimethoxysilane | 0.5 | 0.5 |
| Total | 100 | 100 |

| Storage in cartridge at 50° C. | Start | 4 weeks | Start | 4 weeks |
|---|---|---|---|---|
| Shore A (4 weeks n.c.) | 62 | 15 | 69 | 64 |
| Tensile strength (1 week | 2.73 | 0.59 | 3.61 | 3.58 |
| n.c. + 1 week 50° C.) [MPa] | | | | |
| Elongation at break (1 week | 108 | 81 | 115 | 114 |
| n.c. + 1 week 50° C.) [%] | | | | |

n.c. = standard conditions, 23° C./50% r.h.

### Example 2

The compositions according to example 1 were applied with a composition consisting of silane-terminated polyether polymers as wedge samples of decreasing thickness and stored in a xenon weathering device. While the layer based on silane-terminated polyethers showed the first cracks after only 2000 h of artificial weathering, the composition based on silane-terminated polyesters is still undamaged even after 8000 h.

This effect is enhanced when these layers are applied to copper or bitumen or are in contact with copper or bitumen.

Blends of the composition of the invention with a proportion of silane-terminated polyether polymers also show much better weathering stability than compositions based on pure silane-terminated polyether polymers or pure silane-terminated polyurethane polymers.

### Example 3

The stability of the polymers of the invention was compared with those having a higher polyether content:

| Example | 3A | 3B | 3C | 3D |
|---|---|---|---|---|
| Polyester (MPeD/AA) according to example 1 | 16 | 12.8 | 9.6 | 8 |
| Polyether (STP E-35, Wacker) | | 3.2 | 6.4 | 8 |
| Vinyltrimethoxysilane | 1 | 1 | 1 | 1 |
| GCC (treated calcium carbonate), d50: 0.9 μm | 29.2 | 29.2 | 29.2 | 29.2 |
| GCC (treated calcium carbonate), d50: 1.4 μm | 29.2 | 29.2 | 29.2 | 29.2 |
| Titanium dioxide | 3.1 | 3.1 | 3.1 | 3.1 |
| Addworks 720 (HALS/AO/UVA) | 0.2 | 0.2 | 0.2 | 0.2 |
| Plasticizer | 18.9 | 18.9 | 18.9 | 18.9 |
| Oligomeric aminosilanes | 1 | 1 | 1 | 1 |
| Secondary aminosilane | 1.4 | 1.4 | 1.4 | 1.4 |
| DBU | | | | |
| K-KAT 670 | | | | |
| TIB-KAT 616 | | | | |
| TIB-KAT 716 | | | | |
| Total [g] | 100 | 100 | 100 | 100 |
| Coating on copper, 7 d n.c. | OK | OK | OK | OK |
| Coating on copper, 336 h Osram | OK | OK | OK | OK |
| Coating on copper, 1008 h Osram | OK | OK | OK | chalky |
| Coating on copper, 1176 h Osram | OK | OK | OK | chalky |
| Coating on copper, 1464 h Osram | OK | OK | OK | chalky |
| Coating on copper, 1680 h Osram | OK | OK | OK | chalky |
| Coating on copper, 1848 h Osram | OK | OK | OK | chalky |
| Coating on copper, 1992 h Osram | OK | OK | OK | chalky |
| Coating on copper, 2184 h Osram | OK | OK | OK | chalky |
| Coating on copper, 2688 h Osram | OK | OK | slightly chalky | chalky |
| Coating on copper, 3120 h Osram | OK | OK | slightly chalky | loss of adhesion |
| Coating on copper, 3504 h Osram | OK | OK | slightly chalky | — |
| Coating on copper, 3864 h Osram | OK | OK | slightly chalky | — |
| | | | OK | OK |
| Coating on bitumen, 7 d n.c. | OK | OK | OK | OK |
| Coating on bitumen, 10 months outdoors, | OK | OK | OK | OK |
| cracks by eye | | | | |
| Coating on bitumen, 10 months outdoors, | superficial | superficial | superficial | superficial |
| 10x magnification | | | | |
| Loss [mm] of wedge sample, weathering | 0 | 1 | 1 | 1 |
| according to ISO 4892-2, A1: 2004, 5000 h | | | | |
| Loss [mm] of wedge sample, weathering | 1 | 2 | 2 | 3 |
| according to ISO 4892-2, A1: 2004, 7500 h | | | | |

| Example | 3E | 3F | 3G |
|---|---|---|---|
| Polyester (MPeD/AA) according to example 1 | 6.4 | 4.8 | 3.2 |
| Polyether (STP E-35, Wacker) | 9.6 | 11.2 | 12.8 |
| Vinyltrimethoxysilane | 1 | 1 | 1 |
| GCC (treated calcium carbonate), d50: 0.9 μm | 29.2 | 29.2 | 29.2 |
| GCC (treated calcium carbonate), d50: 1.4 μm | 29.2 | 29.2 | 29.2 |
| Titanium dioxide | 3.1 | 3.1 | 3.1 |
| Addworks 720 (HALS/AO/UVA) | 0.2 | 0.2 | 0.2 |
| Plasticizer | 18.9 | 18.9 | 18.9 |
| Oligomeric aminosilanes | 1 | 1 | 1 |
| Secondary aminosilane | 1.4 | 1.4 | 1.4 |
| DBU | | | |
| K-KAT 670 | | | |
| TIB-KAT 616 | | | |
| TIB-KAT 716 | | | |
| Total [g] | 100 | 100 | 100 |
| Coating on copper, 7 d n.c. | OK | OK | OK |
| Coating on copper, 336 h Osram | chalky | chalky | highly chalky |
| Coating on copper, 1008 h Osram | chalky | chalky | highly chalky |
| Coating on copper, 1176 h Osram | chalky | chalky | highly chalky |
| Coating on copper, 1464 h Osram | chalky | chalky | highly chalky |
| Coating on copper, 1680 h Osram | chalky | chalky | highly chalky |
| Coating on copper, 1848 h Osram | chalky | chalky | liquefy contact |
| | | | surface |
| Coating on copper, 1992 h Osram | chalky | chalky | liquefy contact |
| | | | surface |
| Coating on copper, 2184 h Osram | liquefy contact | liquefy contact | — |
| | surface | surface | |
| Coating on copper, 2688 h Osram | — | — | — |
| Coating on copper, 3120 h Osram | — | — | — |
| Coating on copper, 3504 h Osram | — | — | — |
| Coating on copper, 3864 h Osram | — | — | — |
| Coating on bitumen, 7 d n.c. | OK | OK | OK |
| Coating on bitumen, 10 months outdoors, | clearly apparent | clearly apparent | clearly apparent |
| cracks by eye | | | |
| Coating on bitumen, 10 months outdoors, | n.a. | n.a. | n.a. |
| 10x magnification | | | |
| Loss [mm] of wedge sample, weathering | 1 | 1 | 1 (chalky) |
| according to ISO 4892-2, A1: 2004, 5000 h | | | |
| Loss [mm] of wedge sample, weathering | 5 | 6 | 9 (chalky) |
| according to ISO 4892-2, A1: 2004, 7500 h | | | |

| Example | 3G | 3H |
|---|---|---|
| Polyester (MPeD/AA) according to example 1 | 1.6 | |
| Polyether (STP E-35, Wacker) | 14.4 | 16 |
| Vinyltrimethoxysilane | 1 | 1 |
| GCC (treated calcium carbonate), d50: 0.9 μm | 29.2 | 29.2 |
| GCC (treated calcium carbonate), d50: 1.4 μm | 29.2 | 29.2 |
| Titanium dioxide | 3.1 | 3.1 |
| Addworks 720 (HALS/AO/UVA) | 0.2 | 0.2 |
| Plasticizer | 18.9 | 18.9 |
| Oligomeric aminosilanes | 1 | 1 |
| Secondary aminosilane | 1.4 | 1.4 |
| DBU | | |
| K-KAT 670 | | |
| TIB-KAT 616 | | |
| TIB-KAT 716 | | |
| Total [g] | 100 | 100 |
| Coating on copper, 7 d n.c. | OK | OK |
| Coating on copper, 336 h Osram | liquefy contact | liquefy contact |
| | surface | surface |
| Coating on copper, 1008 h Osram | liquefy contact | liquefy contact |
| | surface | surface |
| Coating on copper, 1176 h Osram | — | — |
| Coating on copper, 1464 h Osram | — | — |
| Coating on copper, 1680 h Osram | — | — |
| Coating on copper, 1848 h Osram | — | — |
| Coating on copper, 1992 h Osram | — | — |
| Coating on copper, 2184 h Osram | — | — |
| Coating on copper, 2688 h Osram | — | — |
| Coating on copper, 3120 h Osram | — | — |
| Coating on copper, 3504 h Osram | — | — |
| Coating on copper, 3864 h Osram | — | — |
| Coating on bitumen, 7 d n.c. | OK | OK |
| Coating on bitumen, 10 months outdoors, | clearly apparent | clearly apparent |
| cracks by eye | | |
| Coating on bitumen, 10 months outdoors, | n.a. | n.a. |
| 10x magnification | | |
| Loss [mm] of wedge sample, weathering | 2 (chalky) | 5 (chalky) |
| according to ISO 4892-2, A1: 2004, 5000 h | | |
| Loss [mm] of wedge sample, weathering | 10 (chalky) | 12 (chalky) |
| according to ISO 4892-2, A1: 2004, 7500 h | | |

The following tests were conducted with the inventive composition and the comparative compositions:
[symbol] Coating on copper, visual observation (chalkiness and liquefaction of the coating)
[symbol] Coating on bitumen, cracking on storage outdoors in the sun
[symbol] Wedge specimens in xenon test device (decreasing thickness of the wedge; the wedge is at its most sensitive at the thinnest point)

It was shown that there is a distinct decrease in weathering stability with a higher proportion of polyether polymer (Wacker STP-E35).

### Example 4

The example shows the effect of the catalyst and the effect of the diol monomer units having a side group on storage stability.

### Materials Used

Dynacoll® 7250 (Evonik): linear polyester polyol prepared from ethane-1,2-diol (unbranched), hexane-1,6-diol (unbranched), 2,2-dimethylpropane-1,3-diol (branched) with adipic acid, where the polyol has an average molar mass of 5500 g/mol. According to NMR analyses, Dynacoll 7250, based on the diol components, contains about 17 mol % of branched diol (2,2-dimethylpropane-1,3-diol).

Dynacoll® 7231 (sold at Evonik): linear polyester polyol prepared from ethane-1,2-diol (unbranched), hexane-1,6-diol (unbranched), 2,2-dimethylpropane-1,3-diol (branched) with adipic acid, terephthalic acid and isophthalic acid, where the polyol has an average molar mass of 3500 g/mol.

Dynacoll® 7230 (sold at Evonik): linear polyester polyol prepared from ethane-1,2-diol (unbranched), hexane-1,6-diol (unbranched), 2,2-dimethylpropane-1,3-diol (branched) with adipic acid, terephthalic acid and isophthalic acid, where the polyol has an average molar mass of 3500 g/mol.

The hydroxy-terminated polyols were modified to give silane-terminated polymers, after prior drying at 100° C. under reduced pressure, as follows: breaking of the vacuum with nitrogen. cooling under N₂ to 80° C. Addition of urethane catalyst in the form of a mixture of cobalt(II) neodecanoate in white spirit, where the content of cobalt(II) ions was chosen according to the reactivity of the prepolymers and was between 4-10 ppm. Homogenization was followed by the addition of an equimolar amount of 3-(trimethoxysilyl)propyl isocyanates. The reaction was left to run at 80° C. until the isocyanate band, which is detectable at around 2270 cm⁻¹ in the FTIR analysis, has been fully depleted. Subsequently, the products were discharged into a sealed reservoir vessel and stored under nitrogen until further processing according to the examples.

| | According to the invention | Not according to the invention |
|---|---|---|
| Polymer (MPeD/AA) as per example 1 | 16 | 16 |
| Polymer (7250) | | |
| Polymer (7230) | | |
| Polymer (7231) | | |
| Polymer (NPG/EPeD/SA) | | |
| Polymer (MPeD/SA) | | |
| Vinyltrimethoxysilane | 1 | 1 |
| GCC (treated calcium carbonate), d50: 0.9 μm | 29.2 | 29.2 |
| GCC (treated calcium carbonate), d50: 1.4 μm | 29.2 | 29.2 |
| Titanium dioxide | 3.1 | 3.1 |
| Addworks 720 (HALS/AO/UVA) | 0.2 | 0.2 |
| Plasticizer | 18.9 | 18.9 |
| Oligomeric aminosilane | 1 | 1 |
| Secondary aminosilane | 1.4 | 1.4 |
| DBU | | 0.1 |
| K-KAT 670 (US2022/0220245A1) | | |
| TIB-KAT 616 | | |
| TIB-KAT 716 | | |
| Total [g] | 100 | 100.1 |

| Storage for 4 weeks under the following conditions | initial | n.c. | 50° C. | initial | n.c. | 50° C. |
|---|---|---|---|---|---|---|
| Tensile strength (1 week n.c.) | 2.50 | 2.30 | 2.20 | 2.26 | 1.73 | 1.28 |
| Elongation at break (1 week n.c.) | 60% | 52% | 74% | 72% | 62% | 50% |
| Evolution of tensile strength after storage by | — | 92% | 88% | — | 77% | 57% |
| comparison with starting value | | | | | | |

| | Not according to the invention | Not according to the invention |
|---|---|---|
| Polymer (MPeD/AA) as per example 1 | 16 | 16 |
| Polymer (7250) | | |
| Polymer (7230) | | |
| Polymer (7231) | | |
| Polymer (NPG/EPeD/SA) | | |
| Polymer (MPeD/SA) | | |
| Vinyltrimethoxysilane | 1 | 1 |
| GCC (treated calcium carbonate), d50: 0.9 μm | 29.2 | 29.2 |
| GCC (treated calcium carbonate), d50: 1.4 μm | 29.2 | 29.2 |
| Titanium dioxide | 3.1 | 3.1 |
| Addworks 720 (HALS/AO/UVA) | 0.2 | 0.2 |
| Plasticizer | 18.9 | 18.9 |
| Oligomeric aminosilane | 1 | 1 |
| Secondary aminosilane | 1.4 | 1.4 |
| DBU | | |
| K-KAT 670 (US2022/0220245A1) | 0.5 | |
| TIB-KAT 616 | | 0.5 |
| TIB-KAT 716 | | |
| Total [g] | 100.5 | 100.5 |

| Storage for 4 weeks under the following conditions | initial | n.c. | 50° C. | initial | n.c. | 50° C. |
|---|---|---|---|---|---|---|
| Tensile strength (1 week n.c.) | 2.44 | 1.96 | 1.29 | 2.02 | <0.1 | <0.1 |
| Elongation at break (1 week n.c.) | 56% | 49% | 52% | 55% | n.a.* | n.a.* |
| Evolution of tensile strength after storage by | — | 80% | 53% | — | 0% | 0% |
| comparison with starting value | | | | | | |

| | Not according to the invention | Not according to the invention |
|---|---|---|
| Polymer (MPeD/AA) as per example 1 | 16 | |
| Polymer (7250) | | 16 |
| Polymer (7230) | | |
| Polymer (7231) | | |
| Polymer (NPG/EPeD/SA) | | |
| Polymer (MPeD/SA) | | |
| Vinyltrimethoxysilane | 1 | 1 |
| GCC (treated calcium carbonate), d50: 0.9 μm | 29.2 | 29.2 |
| GCC (treated calcium carbonate), d50: 1.4 μm | 29.2 | 29.2 |
| Titanium dioxide | 3.1 | 3.1 |
| Addworks 720 (HALS/AO/UVA) | 0.2 | 0.2 |
| Plasticizer | 18.9 | 18.9 |
| Oligomeric aminosilane | 1 | 1 |
| Secondary aminosilane | 1.4 | 1.4 |
| DBU | | |
| K-KAT 670 (US2022/0220245A1) | | |
| TIB-KAT 616 | | |
| TIB-KAT 716 | 0.5 | |
| Total [g] | 100.5 | 100 |

| Storage for 4 weeks under the following conditions | initial | n.c. | 50° C. | initial | n.c. | 50° C. |
|---|---|---|---|---|---|---|
| Tensile strength (1 week n.c.) | 2.47 | 2.03 | 0.55 | 2.02 | 1.49 | 0.27 |
| Elongation at break (1 week n.c.) | 56% | 52% | 40% | 64% | 59% | 37% |
| Evolution of tensile strength after storage by | — | 82% | 22% | — | 74% | 13% |
| comparison with starting value | | | | | | |

| | Not according to the invention | Not according to the invention |
|---|---|---|
| Polymer (MPeD/AA) as per example 1 | | |
| Polymer (7250) | | |
| Polymer (7230) | 16 | |
| Polymer (7231) | | 16 |
| Polymer (NPG/EPeD/SA) | | |
| Polymer (MPeD/SA) | | |
| Vinyltrimethoxysilane | 1 | 1 |
| GCC (treated calcium carbonate), d50: 0.9 μm | 29.2 | 29.2 |
| GCC (treated calcium carbonate), d50: 1.4 μm | 29.2 | 29.2 |
| Titanium dioxide | 3.1 | 3.1 |
| Addworks 720 (HALS/AO/UVA) | 0.2 | 0.2 |
| Plasticizer | 18.9 | 18.9 |
| Oligomeric aminosilane | 1 | 1 |
| Secondary aminosilane | 1.4 | 1.4 |
| DBU | | |
| K-KAT 670 (US2022/0220245A1) | | |
| TIB-KAT 616 | | |
| TIB-KAT 716 | | |
| Total [g] | 100 | 100 |

| Storage for 4 weeks under the following conditions | initial | n.c. | 50° C. | initial | n.c. | 50° C. |
|---|---|---|---|---|---|---|
| Tensile strength (1 week n.c.) | 2.15 | 1.19 | <0.1* | 2.08 | 1.31 | <0.1* |
| Elongation at break (1 week n.c.) | 54% | 45% | n.a.* | 48% | 45% | n.a.* |
| Evolution of tensile strength after storage by | — | 55% | 0% | — | 63% | 0% |
| comparison with starting value | | | | | | |

| | According to the invention | According to the invention |
|---|---|---|
| Polymer (MPeD/AA) as per example 1 | | |
| Polymer (7250) | | |
| Polymer (7230) | | |
| Polymer (7231) | | |
| Polymer (NPG/EPeD/SA) | 16 | |
| Polymer (MPeD/SA) | | 16 |
| Vinyltrimethoxysilane | 1 | 1 |
| GCC (treated calcium carbonate), d50: 0.9 μm | 29.2 | 29.2 |
| GCC (treated calcium carbonate), d50: 1.4 μm | 29.2 | 29.2 |
| Titanium dioxide | 3.1 | 3.1 |
| Addworks 720 (HALS/AO/UVA) | 0.2 | 0.2 |
| Plasticizer | 18.9 | 18.9 |
| Oligomeric aminosilane | 1 | 1 |
| Secondary aminosilane | 1.4 | 1.4 |
| DBU | | |
| K-KAT 670 (US2022/0220245A1) | | |
| TIB-KAT 616 | | |
| TIB-KAT 716 | | |
| Total [g] | 100 | 100 |

| Storage for 4 weeks under the following conditions | initial | n.c | 50° C. | initial | n.c. | 50° C. |
|---|---|---|---|---|---|---|
| Tensile strength (1 week n.c.) | 2.78 | 2.87 | 2.32 | 2.71 | 2.73 | 2.32 |
| Elongation at break (1 week n.c.) | 50% | 58% | 48% | 62% | 49% | 48% |
| Evolution of tensile strength after storage by | — | 100% | 83% | — | 100% | 86% |
| comparison with starting value | | | | | | |

n.c. = standard climatic conditions, 23° C./50% r.h.
*no curing
(*2) >90% cohesive failure
(*3) <40% cohesive failure
(*4) 40-90% cohesive failure
K-KAT 670 (sold by King Industry): zinc carboxylate/DBU mixture
TIB-KAT 616 (purchased by TIB Chemicals): zinc neodecanoate
TIB-KAT 716 (purchased by TIB Chemicals): bismuth carboxylate
DBU (n.a.): diazabicycloundecene

For the performance of the experiments, Osram Vitalux 300W was used with a distance from the test specimen of 24 cm and a xenon tester: ISO 4892-2, A1:2004.

1. A method comprising applying a composition containing at least 20% by weight of a silane-terminated polymer of the formula (I) or (II) 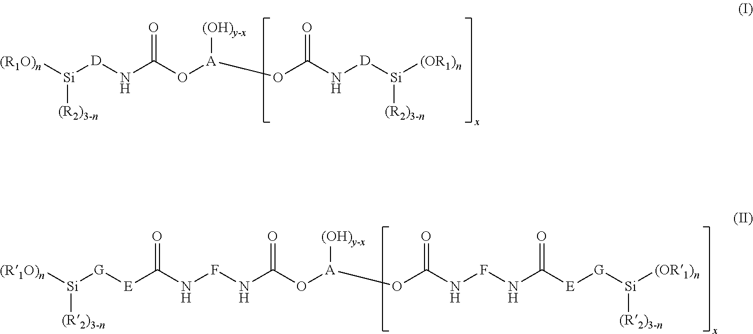
to a substrate as a surface seal or joining material,
where
the percentages by weight are based on the total content of silane-terminated polymers,
D represents a linear or branched hydrocarbon group which has 1 to 20 hydrocarbon atoms and may optionally be interrupted by heteroatoms selected from the group consisting of oxygen, nitrogen and sulfur,
A is a polymer backbone selected from the group consisting of a polycarbonate, a polyester, a copolymer containing a polyester and/or a polycarbonate and a polymer containing at least one ester group and/or carbonate group, and where this polymer backbone contains multiple diol monomer units,
R₁, R₂, R₁′ and R₂′ are each independently a linear, branched or cyclic hydrocarbon radical which has 1 to 10 carbon atoms and may optionally comprise one or more heteroatoms selected from the group consisting of oxygen, sulfur and nitrogen,
n is 1, 2 or 3,
x and y are natural numbers from 1 to 10,
G is a linear or branched hydrocarbon group which has 1 to 20 hydrocarbon atoms and may optionally be interrupted by heteroatoms selected from the group consisting of oxygen, nitrogen and sulfur,
F is a linear, branched or cyclic organic radical which does not contain any isocyanate-reactive groups,
E is a functional group selected from the group consisting of NH, NR₄ and S, where
R₄ represents a linear, branched or cyclic hydrocarbon radical which has 1 to 10 carbon atoms and may optionally comprise one or more heteroatoms selected from the group consisting of oxygen, sulfur and nitrogen,
wherein
at least 60% of the diol monomer units present in the polymer backbone A are a diol of the general formula III 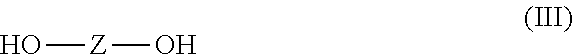
where
Z is a saturated or unsaturated hydrocarbon chain that may optionally contain one or more heteroatoms selected from the group consisting of oxygen, sulfur and a tertiary nitrogen, wherein Z has
(a) at least one side chain and/or
(b) at least one cyclic ring system and/or
(c) at least one double bond.
and the composition contains a curing catalyst and is free of
i. curing catalysts or residues thereof selected from the group of base catalysts having a pKa of greater than 15, and
ii. by-products that can form via elimination of a leaving group in the case of silane termination of the polymer.

2. The method as claimed in claim 1, wherein the composition is free of phthalate.

3. The method as claimed in claim 1, wherein the curing catalyst present in the composition contains an aminoalkoxysilane or consists of an aminoalkoxysilane or of a mixture of aminoalkoxysilanes.

4. The method as claimed in claim 1, wherein the composition contains a curing catalyst which is additionally free of a metal catalyst or residues thereof.

5. The method as claimed in claim 1, wherein Z has at least one side chain.

6. The method as claimed in claim 1, wherein Z is an alkylene group having at least one side chain.

7. The method as claimed in claim 1, wherein at least 75% of the diol monomer units present in the polymer backbone A contain a diol of the general formula III.

8. The method as claimed in claim 1, wherein the side chain is selected from the group consisting of methyl, ethyl, propyl, butyl, acrylate and methacrylate.

9. The method as claimed in claim 1, wherein the diol of the formula III is selected from the group consisting of neopentyl glycol, propane-1,2-diol, cyclohexane-1,4-dimethanol, 3-methylpentane-1,5-diol, 2-methylpentane-2,4-diol, hexane-2,5-diol, 2-butyl-2-ethylpropane-1,3-diol, 2-methylpropane-1,3-diol, 3-ethylpentane-1,5-diol, 2,4-diethylpentane-1,5-diol, 2,2,4-trimethylpentane-1,3-diol, butane-2,3-diol, 2-ethylpentane-1,5-diol, 2,2-dimethylpropane-1,3-diol, 1,5-hexadiene-3,4-diol, 7-octene-1,2-diol and (9Z,12Z)-18-[(6Z,9Z)-18-hydroxyoctadeca-6,9-dienoxy]octadeca-9,12-dien-1-ol or a mixture thereof.

10. The method as claimed in claim 1, wherein the silane-terminated polymers are selected from the group consisting of 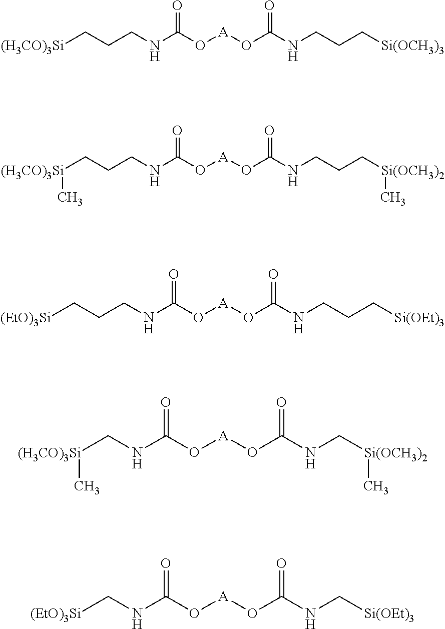
where the polymer backbone A contains polyester units formed from monomer units selected from the group consisting of:

| | | |
|---|---|---|
| A1 | neopentylglycol | adipic acid |
| A2 | propane-1,2-diol | adipic acid |
| A3 | cyclohexane-1,4-dimethanol | adipic acid |
| A4 | 3-methylpentane-1,5-diol | adipic acid |
| A5 | 2-methylpentane-2,4-diol | adipic acid |
| A6 | hexane-2,5-diol | adipic acid |
| A7 | 2-butyl-2-ethylpropane-1,3-diol | adipic acid |
| A8 | 2-methylpropane-1,3-diol | adipic acid |
| A9 | 3-ethylpentane-1,5-diol | adipic acid |
| A10 | 2,4-diethylpentane-1,5-diol | adipic acid |
| A11 | 2,2,4-trimethylpentane-1,3-diol | adipic acid |
| A12 | butane-2,3-diol | adipic acid |
| A13 | 2-ethylpentane-1,5-diol | adipic acid |
| A14 | 2,2-dimethylpropane-1,3-diol | adipic acid |
| A15 | 2-ethylhexane-1,3-diol | adipic acid |
| A16 | 1,5-hexadiene-3,4-diol | adipic acid |
| A17 | 7-octene-1,2-diol | adipic acid |
| A18 | (9Z,12Z)-18-[(6Z,9Z)-18- | adipic acid |
| | hydroxyoctadeca-6,9- | |
| | dienoxyloctadeca-9,12-dien-1-ol | |
| A19 | neopentyl glycol | azelaic acid |
| A20 | propane-1,2-diol | azelaic acid |
| A21 | cyclohexane-1,4-dimethanol | azelaic acid |
| A22 | 3-methylpentane-1,5-diol | azelaic acid |
| A23 | 2-methylpentane-2,4-diol | azelaic acid |
| A24 | hexane-2,5-diol | azelaic acid |
| A25 | 2-butyl-2-ethylpropane-1,3-diol | azelaic acid |
| A26 | 2-methylpropane-1,3-diol | azelaic acid |
| A27 | 3-ethylpentane-1,5-diol | azelaic acid |
| A28 | 2,4-diethylpentane-1,5-diol | azelaic acid |
| A29 | 2,2,4-trimethylpentane-1,3-diol | azelaic acid |
| A30 | butane-2,3-diol | azelaic acid |
| A31 | 2-ethylpentane-1,5-diol | azelaic acid |
| A32 | 2,2-dimethylpropane-1,3-diol | azelaic acid |
| A33 | 2-ethylhexane-1,3-diol | azelaic acid |
| A34 | 1,5-hexadiene-3,4-diol | azelaic acid |
| A35 | 7-octene-1,2-diol | azelaic acid |
| A36 | (9Z,12Z)-18-[(6Z,9Z)-18- | azelaic acid |
| | hydroxyoctadeca-6,9- | |
| | dienoxyloctadeca-9,12-dien-1-ol | |
| A37 | neopentyl glycol | sebacic acid |
| A38 | propane-1,2-diol | sebacic acid |
| A39 | cyclohexane-1,4-dimethanol | sebacic acid |
| A40 | 3-methylpentane-1,5-diol | sebacic acid |
| A41 | 2-methylpentane-2,4-diol | sebacic acid |
| A42 | hexane-2,5-diol | sebacic acid |
| A43 | 2-butyl-2-ethylpropane-1,3-diol | sebacic acid |
| A44 | 2-methylpropane-1,3-diol | sebacic acid |
| A45 | 3-ethylpentane-1,5-diol | sebacic acid |
| A46 | 2,4-diethylpentane-1,5-diol | sebacic acid |
| A47 | 2,2,4-trimethylpentane-1,3-diol | sebacic acid |
| A48 | butane-2,3-diol | sebacic acid |
| A49 | 2-ethylpentane-1,5-diol | sebacic acid |
| A50 | 2,2-dimethylpropane-1,3-diol | sebacic acid |
| A51 | 2-ethylhexane-1,3-diol | sebacic acid |
| A52 | 1,5-hexadiene-3,4-diol | sebacic acid |
| A53 | 7-octene-1,2-diol | sebacic acid |
| A54 | (9Z,12Z)-18-[(6Z,9Z)-18- | sebacic acid |
| | hydroxyoctadeca-6,9- | |
| | dienoxyloctadeca-9,12-dien-1-ol | |
| A55 | neopentyl glycol | terephthalic acid |
| A56 | propane-1,2-diol | terephthalic acid |
| A57 | cyclohexane-1,4-dimethanol | terephthalic acid |
| A58 | 3-methylpentane-1,5-diol | terephthalic acid |
| A59 | 2-methylpentane-2,4-diol | terephthalic acid |
| A60 | hexane-2,5-diol | terephthalic acid |
| A61 | 2-butyl-2-ethylpropane-1,3-diol | terephthalic acid |
| A62 | 2-methylpropane-1,3-diol | terephthalic acid |
| A63 | 3-ethylpentane-1,5-diol | terephthalic acid |
| A64 | 2,4-diethylpentane-1,5-diol | terephthalic acid |
| A65 | 2,2,4-trimethylpentane-1,3-diol | terephthalic acid |
| A66 | butane-2,3-diol | terephthalic acid |
| A67 | 2-ethylpentane-1,5-diol | terephthalic acid |
| A68 | 2,2-dimethylpropane-1,3-diol | terephthalic acid |
| A69 | 2-ethylhexane-1,3-diol | terephthalic acid |
| A70 | 1,5-hexadiene-3,4-diol | terephthalic acid |
| A71 | 7-octene-1,2-diol | terephthalic acid |
| A72 | (9Z,12Z)-18-[(6Z,9Z)-18- | terephthalic acid |
| | hydroxyoctadeca-6,9- | |
| | dienoxyloctadeca-9,12-dien-1-ol | |
| A73 | neopentyl glycol | isophthalic acid |
| A74 | propane-1,2-diol | isophthalic acid |
| A75 | cyclohexane-1,4-dimethanol | isophthalic acid |
| A76 | 3-methylpentane-1,5-diol | isophthalic acid |
| A77 | 2-methylpentane-2,4-diol | isophthalic acid |
| A78 | hexane-2,5-diol | isophthalic acid |
| A79 | 2-butyl-2-ethylpropane-1,3-diol | isophthalic acid |
| A80 | 2-methylpropane-1,3-diol | isophthalic acid |
| A81 | 3-ethylpentane-1,5-diol | isophthalic acid |
| A82 | 2,4-diethylpentane-1,5-diol | isophthalic acid |
| A83 | 2,2,4-trimethylpentane-1,3-diol | isophthalic acid |
| A84 | butane-2,3-diol | isophthalic acid |
| A85 | 2-ethylpentane-1,5-diol | isophthalic acid |
| A86 | 2,2-dimethylpropane-1,3-diol | isophthalic acid |
| A87 | 2-ethylhexane-1,3-diol | isophthalic acid |
| A88 | 1,5-hexadiene-3,4-diol | isophthalic acid |
| A89 | 7-octene-1,2-diol | isophthalic acid |
| A90 | (9Z,12Z)-18-[(6Z,9Z)-18- | isophthalic acid |
| | hydroxyoctadeca-6,9- | |
| | dienoxyloctadeca-9,12-dien-1-ol | |
| A91 | neopentyl glycol | naphthalenedicarboxylic acid |
| A92 | propane-1,2-diol | naphthalenedicarboxylic acid |
| A93 | cyclohexane-1,4-dimethanol | naphthalenedicarboxylic acid |
| A94 | 3-methylpentane-1,5-diol | naphthalenedicarboxylic acid |
| A95 | 2-methylpentane-2,4-diol | naphthalenedicarboxylic acid |
| A96 | hexane-2,5-diol | naphthalenedicarboxylic acid |
| A97 | 2-butyl-2-ethylpropane-1,3-diol | naphthalenedicarboxylic acid |
| A98 | 2-methylpropane-1,3-diol | naphthalenedicarboxylic acid |
| A99 | 3-ethylpentane-1,5-diol | naphthalenedicarboxylic acid |
| A100 | 2,4-diethylpentane-1,5-diol | naphthalenedicarboxylic acid |
| A101 | 2,2,4-trimethylpentane-1,3-diol | naphthalenedicarboxylic acid |
| A102 | butane-2,3-diol | naphthalenedicarboxylic acid |
| A103 | 2-ethylpentane-1,5-diol | naphthalenedicarboxylic acid |
| A104 | 2,2-dimethylpropane-1,3-diol | naphthalenedicarboxylic acid |
| A105 | 2-ethylhexane-1,3-diol | naphthalenedicarboxylic acid |
| A106 | 1,5-hexadiene-3,4-diol | naphthalenedicarboxylic acid |
| A107 | 7-octene-1,2-diol | naphthalenedicarboxylic acid |
| A108 | (9Z,12Z)-18-[(6Z,9Z)-18- | naphthalenedicarboxylic acid |
| | hydroxyoctadeca-6,9- | |
| | dienoxyloctadeca-9,12-dien-1-ol | |

11. The method as claimed in claim 1, wherein A contains a polyester.

12. The method as claimed in claim 1, wherein A contains a polyester carbonate.

13. The method as claimed in claim 1, wherein the composition contains at least 25% by weight of a silane-terminated polymer of the formula (I) or (II), where the percentages by weight are based on the total content of silane-terminated polymers.

14. The method as claimed in claim 1, wherein the composition is applied to the substrate as a surface seal for sealing a surface of the substrate against the penetration of water.

15. The method as claimed in claim 1, wherein the substrate is selected from the group consisting of mineral building materials, metals, tar papers, plastics, fiber weaves, glass and ceramic.

16. The method as claimed in claim 1, wherein the substrate is a built structure or a flat roof.

17. The method as claimed in claim 1, wherein the composition is applied to the substrate as a joining material.

18. The method as claimed in claim 1, wherein the composition is applied together with a nonwoven or woven fabric.
